(19) United States
(12) Patent Application Publication
(10) Pub. No.: US 2014/0313767 A1
(43) Pub. Date: Oct. 23, 2014

(54) ELECTRONIC INCENSE ASSEMBLY

(71) Applicant: HON HAI PRECISION INDUSTRY CO., LTD., New Taipei (TW)

(72) Inventor: CHEN-HAN LIN, New Taipei (TW)

(73) Assignee: HON HAI PRECISION INDUSTRY CO., LTD., New Taipei (TW)

(21) Appl. No.: 14/255,027

(22) Filed: Apr. 17, 2014

(30) Foreign Application Priority Data
Apr. 19, 2013 (TW) 102114028

(51) Int. Cl. F21K 99/00

(52) U.S. Cl. CPC F21K 9/52
USPC 362/565

(57) ABSTRACT

An electronic incense assembly includes a light guide member, a light combining member, a substantially hemispherical member, a first light source and a second light source. The light guide member includes a light incident end and a light output end. The light combining member is located at the light incident end. The substantially hemispherical member is located at the light output end. The first and the second light sources emit light with different color chosen from red, green and blue. The light combining member synthesizes light emitted from the first and the second light sources to form a synthesized light. The synthesized light enters the light guide member from the light incident end, reaches the substantially hemispherical member directly and then emits out of the substantially hemispherical member to simulate a burning incense stick.

### FIELD

The present disclosure relates to electronic incense devices, and, particularly, to a low cost electronic incense assembly.

### BACKGROUND

Electronic incense assemblies are integrated with electronic burners. In particular, light sources are installed in the burner. The electronic incense assemblies are stuck in the burner. Each electronic incense assembly includes an optical fiber having an opaque coating on an outer surface and a transparent substantially hemispherical member on an upper end of the optical fiber. Light emitted from a light source is guided to the transparent substantially hemispherical member by the optical fiber to simulate a burning incense stick.

### BRIEF DESCRIPTION OF THE DRAWINGS

FIG. 1 is a cross-sectional view of an electronic incense assembly including a light combining member, according to an exemplary embodiment.

FIG. 2 is a diagrammatic, isometric view of the light combining member of FIG. 1.

### DETAILED DESCRIPTION

Embodiment of the disclosure will now be described in detail, with reference to the accompanying drawings.

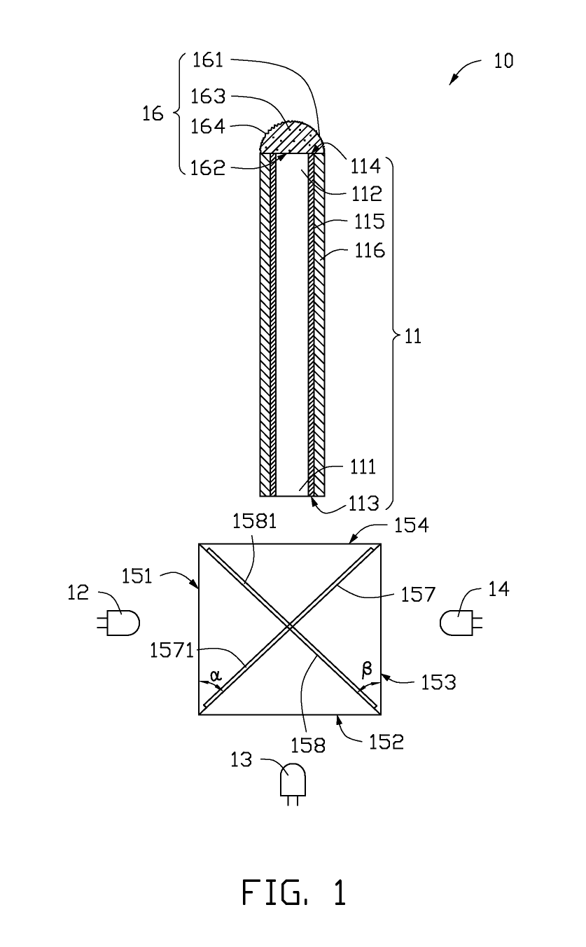

FIG. 1 illustrates an electronic incense assembly 10 in accord with an exemplary embodiment. The electronic incense assembly 10 includes a light guide member 11, a first light source 12, a second light source 13, a third light source 14, a light combining member 15, and a substantially hemispherical member 16.

The first light source 12, the second light source 13 and the third light source 14 are laser diodes. The three light sources 12, 13, and 14 are configured to emit red, green and blue light. In detail, the first light source 12 is configured to emit red light. The second light source 13 is configured to emit green light. The third light source 14 is configured to emit blue light.

The light guide member 11 can be made of transparent material, such as Polymethyl Methacrylate (PMMA), Polycarbonate (PC), silicone, or glass. The light guide member 11 is a tube, which includes a light incident end 111, a light output end 112 opposite to the light incident end 111, and an opaque coating 116 on a circumferential surface 115 of the tube. The light incident end 111 has a first end surface 113. The light output end 112 has a second end surface 114. The first end surface 113 and the second end surface 114 are parallel to each other. The coating 116 may be colored to simulate incense coating of real incense sticks. The light incident end 111 is open.

The light combining member 15 faces the light incident end 111 of the light guide member 11. In this embodiment, the light combining member 15 is an X-cube light combining lens.

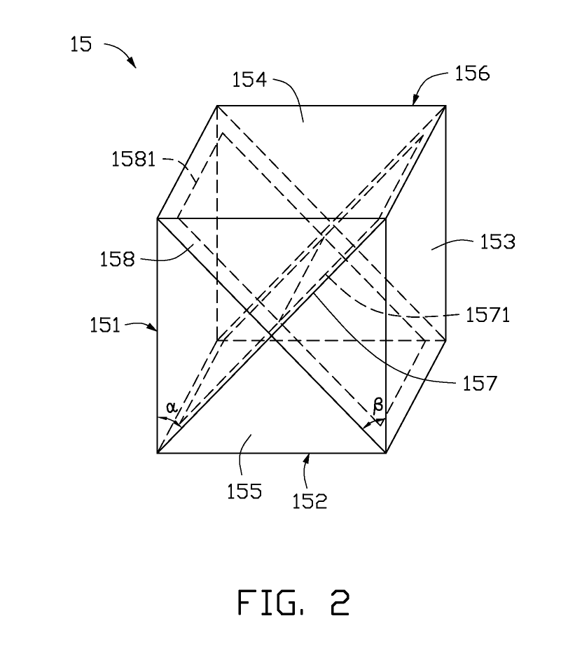

In detail, illustrated in FIG. 2, the light combining member 15 is substantially a cube, and includes a first side surface 151, a second side surface 152, a third side surface 153, a fourth side surface 154, a front surface 155, and a rear surface 156. The first side surface 151, the second side surface 152, the third side surface 153, and the fourth side surface 154 are perpendicularly connected to each other end-to-end. The front surface 155 and the rear surface 156 are opposite to and parallel to each other. The first side surface 151, the second side surface 152, the third side surface 153, and the fourth side surface 154 are interconnected between the front surface 155 and the rear surface 156. The first side surface 151, the second side surface 152, and the third side surface 153 serve as light incident surfaces of the light combining member 15. The fourth side surface 154 serves as a light output surface of the light combining member 15 to face the first end surface 113. A first common surface 157 is defined by two parallel diagonals of the front surface 155 and the rear surface 156, and a second common surface 158 is defined by the other two parallel diagonals of the front surface 155 and the rear surface 156. An included angle α between the first common surface 157 and the first side surface 151 is about 45 degrees. An included angle θ between the second common surface 158 and the third side surface 153 is about 45 degrees as well. A first reflection film 1571, which reflect one of red light, green light or blue light and allow the other two of the three colored lights to penetrate, is formed on the first common surface 157. A second reflection film 1581, which reflects one of red light, green or blue light and allow the other two of the other two of the three colored lights to penetrate, is formed on the second common surface 158. In this embodiment, the first reflection film 1571 reflects the red light and allows the green light and the blue light to penetrate. The second reflection film 1581 reflects the blue light and allows the red light and the green light to penetrate.

FIG. 1 shows that the substantially hemispherical member 16 is located on the second end surface 114. In particular, the substantially hemispherical member 16 seals the light output end 112.

The substantially hemispherical member 16 can be made of transparent material, such as PMMA, PC, silicone, or glass. The substantially hemispherical member 16 includes an outer surface 161 and a bottom surface 162. The bottom surface 162 contacts the second end surface 114. The outer surface 161 is a curve surface. A number of microstructures 164 are formed on the outer surface 161 using a roughening process or an atomized process, in order to achieve a better light scattering effect. A number of light-diffusing particles 163 are distributed in the substantially hemispherical member 16. The light-diffusing particles 163 may be made of silicon dioxide, PMMA, or glass. In this embodiment, the light-diffusing particles 163 are evenly distributed in the substantially hemispherical member 16.

The three light sources 12, 13, and 14 are laser light sources, and face the first side surface 151, the second side surface 152, and the third side surface 153, respectively.

When in work, red laser beams emitted from the first light source 12 enter the light combining member 15 through the first side surface 151, and is then reflected by the first reflection film 1571 toward the fourth side surface 154. Green laser beams emitted from the second light source 13 enter the light combining member 15 through the second side surface 152, and then penetrate the first reflection film 1571 and the second reflection film 1581 to reach the fourth side surface 154. Blue laser beams emitted from the third light source 14 enter the light combining member 15 through the third side surface 153, and is then reflected by the second reflection film 1581 toward the fourth side surface 154. Finally, the red laser beams, the green laser beams and the blue laser beams reaching the fourth side surface 154 are synthesized to form synthesized laser beams. The synthesized laser beams enter the light guide member 11 through the light incident end 111 and are perpendicular to the first end surface 113.

In the light guide member 11, the synthesized laser beams directly reach the substantially hemispherical member 16 without any reflection because of collimation of laser beams. Finally, synthesized laser beams emits out of the substantially hemispherical member 16 to simulate a burning incense stick. In this embodiment, the light intensity of the red laser beam is same as that of the green laser beam, and is larger than that of the blue laser beam, such that the light out of the substantially hemispherical member 16 looks yellow.

In some embodiments, two of the three light sources 12, 13, and 14 emit light, while the other one do not emit light.

In some embodiments, the light guide member 15 and the substantially hemispherical member 16 could be integral structure. In this case, the light-diffusing particles 163 in the substantially hemispherical member 16 are distributed near the outer surface 161 to decrease light dissipation in the light guide member 15.

Even though numerous characteristics and advantages of the present embodiments have been set forth in the foregoing description, together with details of the structures and functions of the embodiments, the disclosure is illustrative only, and changes may be made in detail, especially in the matters of shape, size, and arrangement of parts within the principles of the disclosure to the full extent indicated by the broad general meaning of the terms in which the appended claims are expressed.

What is claimed is:

1. An electronic incense assembly, comprising:
a light guide member comprising a light incident end and a light output end at opposite sides thereof;
a substantially hemispherical member located at the light output end;
a first light source and a second light source, emitting light with different color chosen from red, green, and blue; and
a light combining member facing the light incident end, synthesizing light emitted from the first and the second light sources to form a synthesized light, the synthesized light entering the light guide member through the light incident end, to reach the substantially hemispherical member, and then emitting out of the substantially hemispherical member to simulate a burning incense stick.

2. The electronic incense assembly of claim 1, wherein the light guide member is a tube, the light incident end has a first end surface, the light output end has a second end surface, and the first end surface is parallel to the second end surface.

3. The electronic incense assembly of claim 2, wherein an opaque coating is formed on a circumferential surface of the light guide member.

4. The electronic incense assembly of claim 2, wherein the substantially hemispherical member seals the light output end.

5. The electronic incense assembly of claim 4, wherein the substantially hemispherical member comprises an outer surface and a bottom surface, and the bottom surface contacts the second end surface.

6. The electronic incense assembly of claim 5, wherein a number of light-diffusing particles are distributed in the substantially hemispherical member.

7. The electronic incense assembly of claim 5, wherein a number of microstructures are formed on the outer surface.

8. The electronic incense assembly of claim 1, wherein the light combining member is an X-cube light combining lens.

9. The electronic incense assembly of claim 1, wherein the intensity of the light emitted from the first light source is different from the intensity of the second light source.

10. The electronic incense assembly of claim 1, further comprising a third light source, wherein color of the light emitted from the third light source is different from those of the first and the second light sources.

11. The electronic incense assembly of claim 10, wherein the first, the second, and the third light sources are laser light sources.

12. The electronic incense assembly of claim 10, wherein the intensity of light emitted from the first light source is same as that of the second light source, and is different from that of the third light source.
